(19) United States
(12) Patent Application Publication
(10) Pub. No.: US 2026/0279245 A1
(43) Pub. Date: Sep. 17, 2026

(54) Electronic device with improved display operation during startup and mode transitions

(71) Applicant: InnoLux Corporation, Miao-Li County (TW)

(72) Inventors: Shuo-Ting HONG, Miao-Li County (TW); Ting-Yao Chu, Miao-Li County (TW); Hung-Kun Chen, Miao-Li County (TW); Cheng-Tso Chen, Miao-Li County (TW)

(73) Assignee: InnoLux Corporation, Miao-Li County (TW)

(21) Appl. No.: 19/547,704

(22) Filed: Feb. 24, 2026

(30) Foreign Application Priority Data
Mar. 13, 2025 (CN) 202510294873.6

(51) Int. Cl. G09G 3/20; G09G 3/32

(52) U.S. Cl. CPC G09G 3/2092; G09G 3/32; G09G 2310/0286; G09G 2310/08; G09G 2320/06; G09G 2330/023; G09G 2330/026; G09G 2340/0435

(57) ABSTRACT

An electronic device includes a control unit and a display component. The control unit provides an initial clock signal and a first frame start pulse signal. The display component is electrically connected to and controlled by the control unit during a plurality of frame periods, including a first frame period and a subsequent second frame period. The control unit causes the initial clock signal to enter a first operable state during the first frame period, and the first frame start pulse signal to enter a second operable state during the second frame period.

### BACKGROUND OF THE DISCLOSURE

### 1. Field of the Disclosure

The disclosure relates to an electronic device, and particularly relates to an electronic device capable of reducing display abnormality.

### 2. Description of the Prior Art

During startup, GOP gate pulse anomalies in the first frame often cause display errors. Additionally, when VRR displays switch from LR to ZR mode, XAO-induced charge release creates instantaneous large currents and voltage drops, disrupting TCON operation and causing display abnormalities

### SUMMARY OF THE DISCLOSURE

According to some embodiments of the disclosure, an electronic device comprises a control unit and a display component. The control unit is configured to provide an initial clock signal and a first frame start pulse signal. The display component is electrically connected to the control unit and controlled by the control unit within a plurality of frame periods. The plurality of frame periods comprises a first frame period and a second frame period immediately following the first frame period. The control unit causes the initial clock signal to enter a first operable state in the first frame period, and the control unit causes the first frame start pulse signal to enter a second operable state in the second frame period.

According to some embodiments of the disclosure, an electronic device comprises a control unit, a display component, a pull-up unit, and a reset transistor. The control unit is configured to provide an initial clock signal and a reset signal. The display component is electrically connected to the control unit and controlled by the control unit within a plurality of frame periods. The pull-up unit is electrically connected to the control unit. The reset transistor is electrically connected to the pull-up unit and has a control terminal for receiving the reset signal. The control unit causes the initial clock signal to enter an operable state in a first frame period, and the control unit sets a voltage of the reset signal to be a reset voltage before the first frame period.

According to some embodiments of the disclosure, an electronic device comprises a control unit and a display component. The control unit is configured to provide an initial clock signal and a first frame start pulse signal. The display component is electrically connected to the control unit and is controlled by the control unit within a plurality of frame periods. When the electronic device operates in a first mode, the control unit causes the first frame start pulse signal to be in an operable state, and provides a black insertion signal to the display component during at least one last frame period before an end of the first mode. When the at least one last frame period ends, the control unit causes the electronic device to enter a sleep mode.

These and other objectives of the present disclosure will no doubt become obvious to those of ordinary skill in the art after reading the following detailed description of the embodiment that is illustrated in the various figures and drawings.

### BRIEF DESCRIPTION OF THE DRAWINGS

FIG. 1 is a functional block diagram of an electronic device according to an embodiment of the present disclosure.

FIG. 2 is a timing diagram of the electronic device shown in FIG. 1.

FIG. 3 is a circuit diagram of a scan unit of the electronic device shown in FIG. 1.

FIG. 4 is another circuit diagram of the scan unit of the electronic device shown in FIG. 1.

FIG. 5 is a timing diagram when the electronic device in FIG. 1 includes the scan unit shown in FIG. 4.

FIG. 6 is another timing diagram when the electronic device in FIG. 1 includes the scan unit shown in FIG. 4.

FIG. 7 is another timing diagram when the electronic device in FIG. 1 includes the scan unit shown in FIG. 4.

FIG. 8 is another timing diagram when the electronic device in FIG. 1 includes the scan unit shown in FIG. 4.

FIG. 9 is another timing diagram when the electronic device in FIG. 1 includes the scan unit shown in FIG. 4.

FIG. 10 is another circuit diagram of the scan unit of the electronic device shown in FIG. 1.

FIG. 11 is another timing diagram of the electronic device shown in FIG. 1.

### DETAILED DESCRIPTION

The drawings show parts of device 10 and are not to scale. Specific element numbers/sizes are schematic. Terms ‘including,’ ‘comprising,’ and ‘having’ are open-ended. Directional terms are for reference only. Ordinal numbers (e.g., ‘first,’ ‘second') distinguish components and do not imply specific order or manufacturing sequence. 'Connected’ or ‘coupled’ includes direct or indirect electrical connections through one or more components. ‘Disconnect’ means no electrical signal flows between components within a specified time.

Certain terms are used throughout the specification and appended claims to refer to particular components. Those skilled in the art should understand that electronic device manufacturers may refer to the same component by different names. This document does not intend to distinguish between components that differ in name but not in function.

In the following specification and claims, the words “including,” “comprising,” “having,” etc. are open-ended terms and should therefore be interpreted as “containing but not limited to.” Thus, when the description of the disclosure uses the terms “including,” “comprising,” and/or “having,” it specifies the presence of the corresponding features, regions, steps, operations, and/or components, but does not exclude the presence of one or more other corresponding features, regions, steps, operations, and/or components.

In this disclosure, the electronic device may include display, light-emitting, or sensing devices. It may use LEDs such as mini LEDs, micro LEDs, or quantum dot LEDs. Technical features from different embodiments may be replaced or combined without departing from the disclosure's spirit.

It should be noted that the technical features in the different embodiments described below can be replaced, reorganized, or mixed with each other to form another embodiment without departing from the spirit of the disclosure.

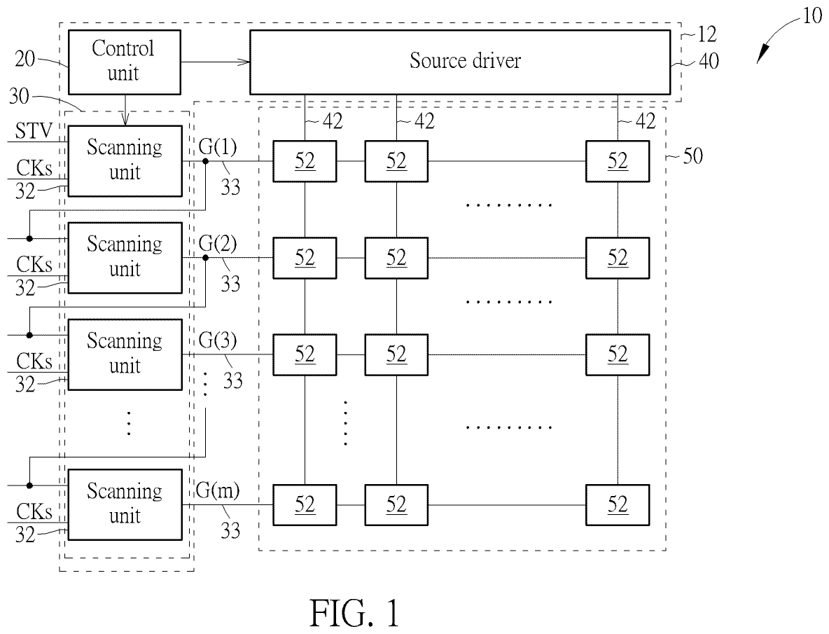

Please refer to FIG. 1, which is a functional block diagram of an electronic device 10 according to an embodiment of the disclosure. The electronic device 10 comprises a driving circuit 12 and a display panel 50. The driving circuit 12 comprises a control unit 20, a gate driver 30, and a source driver 40. The gate driver 30 comprises a plurality of scanning units 32. The display panel 50 comprises a plurality of display components 52 arranged in a plurality of rows and columns. Each scanning unit 32 is coupled to a row of display components 52 through a corresponding scanning line 33, and outputs corresponding scanning signals G(1) to G(m) to the corresponding display components 52. Wherein, m is an integer greater than 1. The source driver 40 is coupled to the display components 52 through data lines 42 to transmit display data to the display components 52, so that the display components 52 display according to the received display data. Each display component 52 may be a pixel. Each scanning unit 32 may be a gate on panel (GOP). The control unit 20 may be a timing controller (TCON) that generates a first frame start pulse signal STV and an initial clock signal CKs, and transmits them to the scanning unit 32.

Each scanning unit 32 comprises two input terminals and one output terminal. The two input terminals of the first scanning unit 32 respectively receive the first frame start pulse signal STV and the initial clock signal CKs, and the output terminal of the first scanning unit 32 outputs the scanning signal G(1); the two input terminals of the second scanning unit 32 respectively receive the scanning signal G(1) and the initial clock signal CKs, and the output terminal of the second scanning unit 32 outputs the scanning signal G(2); and so on.

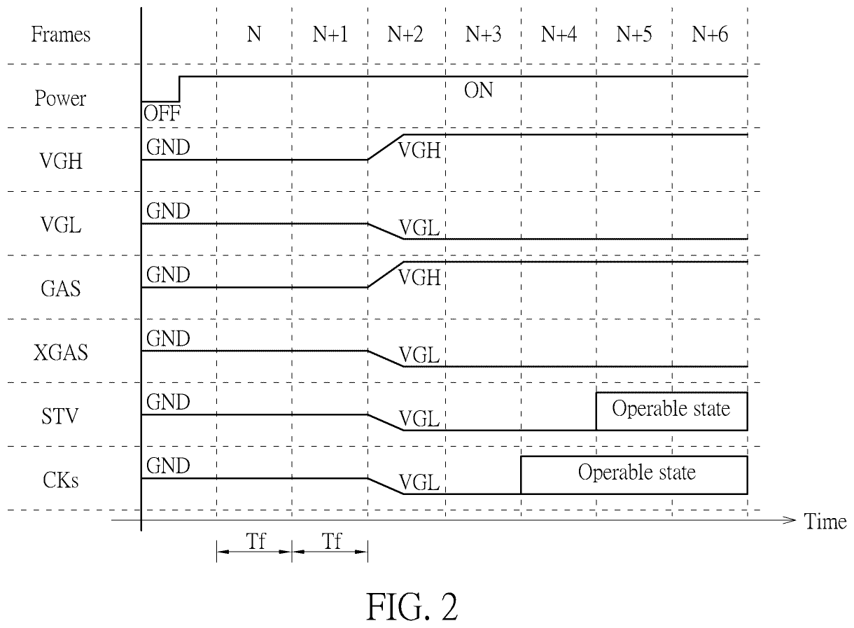

Please refer to FIG. 2, which is a timing diagram of the electronic device 10 shown in FIG. 1. The power of the electronic device 10 is turned on when the power is switched from the OFF state to the ON state. After the electronic device 10 starts operating, its timing may be divided into a plurality of frame periods, and N, (N+1), (N+2), (N+3), (N+4), (N+5), and (N+6) in the figure may be used to represent different frame periods. The length of each frame period is Tf. GND in FIG. 2 represents the ground voltage, VGH represents the gate high voltage, VGL represents the gate low voltage, and the voltage range of the above-mentioned scanning signals G(1) to G(m) will be between the gate low voltage VGL and the gate high voltage VGH. Wherein, the gate high voltage VGH may be a positive voltage, and the gate low voltage VGL may be a negative voltage. In addition, GAS in FIG. 2 represents the first power supply voltage, XGAS represents the second power supply voltage, and the first power supply voltage GAS may be equal to the gate high voltage VGH, and the second power supply voltage XGAS may be equal to the gate low voltage VGL.

In the (N+2)th frame period, the gate high voltage VGH and the first power supply voltage GAS are pulled up from the ground voltage GND to a high voltage, and the gate low voltage VGL, the second power supply voltage XGAS, the first frame start pulse signal STV, and the initial clock signal CKs are pulled down from the ground voltage GND to a low voltage. In the (N+3)th frame period, the gate high voltage VGH and the first power supply voltage GAS are maintained at a high voltage, and the gate low voltage VGL, the second power supply voltage XGAS, the first frame start pulse signal STV, and the initial clock signal CKs are maintained at a low voltage. In the (N+4)th frame period, the control unit 20 controls the initial clock signal CKs to enter an operable state. In the (N+5)th frame period, the control unit 20 controls the first frame start pulse signal STV to enter an operable state. When the initial clock signal CKs is in the operable state, the waveform of the initial clock signal CKs repeatedly appears within one frame period (e.g., when the initial clock signal CKs is in the operable state, the waveform of the initial clock signal CKs in each frame period will be the same and will include at least one clock pulse). Similarly, when the first frame start pulse signal STV is in the operable state, the waveform of the first frame start pulse signal STV in each frame period will be the same (e.g., when the first frame start pulse signal STV is in the operable state, the first frame start pulse signal STV comprises one impulse in each frame period). Since the first frame start pulse signal STV is maintained at a low voltage in the (N+3)th frame period and the (N+4)th frame period, the voltage of the scanning signal G(1) output by the first scanning unit 32 of the gate driver 30 will be equal to the gate low voltage VGL, so that the display component 52 connected thereto will not display. As for the other scanning units 32 of the gate driver 30, because the voltage of the scanning signal G(1) is equal to the gate low voltage VGL, the voltages of the scanning signals G(1) to G(m) output by them will all be equal to the gate low voltage VGL. Therefore, in the (N+3)th frame period and the (N+4)th frame period, the display components 52 of the display panel 50 will not display. In this way, the display components 52 of the electronic device 10 may be prevented from malfunctioning when the electronic device 10 is just turned on, thereby reducing the display abnormality of the display panel 50 of the electronic device 10. After the (N+5)th frame period, since the first frame start pulse signal STV has entered the operable state, the scanning unit 32 of the gate driver 30 may be normally driven, so that the display component 52 of the electronic device 10 can display normally.

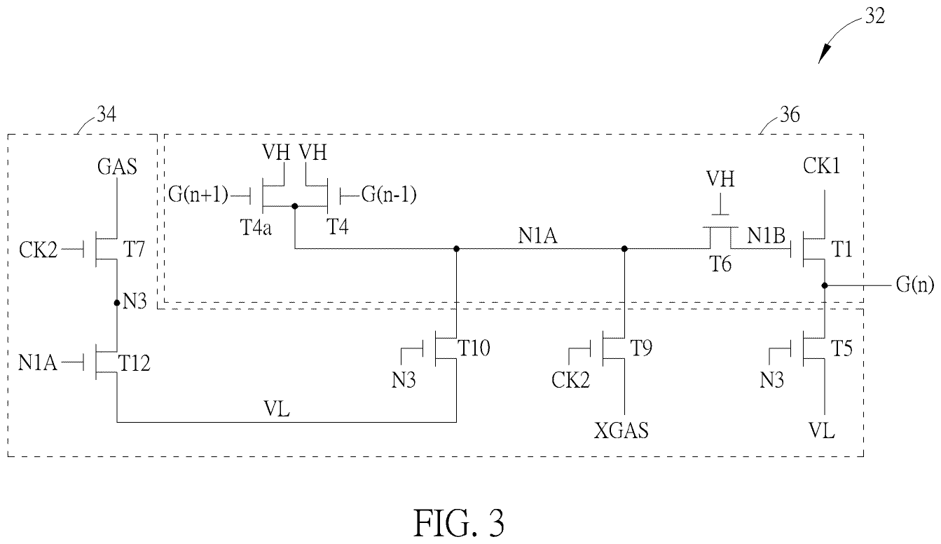

Please refer to FIG. 3, which is a circuit diagram of an embodiment of the scanning unit 32. The scanning unit 32 comprises a pull-down unit 34 and a pull-up unit 36. The pull-down unit 34 is used to pull down the voltage of the scanning line 33 (i.e., pull down the voltage of the scanning signal G(n)), and comprises transistors T5, T7, T9, T10, and T12. The first terminal of the transistor T7 receives the first power supply voltage GAS, the second terminal of the transistor T7 is coupled to the node N3, and the control terminal of the transistor T7 receives the clock signal CK2. The first terminal of the transistor T12 is coupled to the node N3, the second terminal of the transistor T12 receives the low voltage VL, and the control terminal of the transistor T12 is coupled to the node N1A. Wherein, the low voltage VL may be equal to the gate low voltage VGL. The first terminal of the transistor T10 is coupled to the node N1A, the second terminal of the transistor T10 receives the low voltage VL, and the control terminal of the transistor T10 is coupled to the node N3. The first terminal of the transistor T9 is coupled to the node N1A, the second terminal of the transistor T9 receives the second power supply voltage XGAS, and the control terminal of the transistor T9 receives the clock signal CK2. The first terminal of the transistor T5 outputs the scanning signal G(n), the second terminal of the transistor T5 receives the low voltage VL, and the control terminal of the transistor T5 receives the clock signal CK2. Wherein, n is a positive integer, and 1≤n≤m. The pull-up unit 36 is used to pull up the voltage of the scanning line 33 (i.e., pull up the voltage of the scanning signal G(n)), and comprises transistors T4, T4a, T6, and T1. The first terminal of the transistor T4 receives the high voltage VH, the second terminal of the transistor T4 is coupled to the node N1A, and the control terminal of the transistor T4 receives the scanning signal G(n−1) of the previous stage. Wherein, the high voltage VH may be equal to the gate high voltage VGH. The first terminal of the transistor T4a receives the high voltage VH, the second terminal of the transistor T4a is coupled to the node N1A, and the control terminal of the transistor T4 receives the scanning signal G(n+1) of the next stage. The first terminal of the transistor T6 is coupled to the node N1A, the second terminal of the transistor T6 is coupled to the node N1B, and the control terminal of the transistor T6 receives the high voltage VH. The first terminal of the transistor T1 receives the clock signal CK1, the second terminal of the transistor T1 outputs the scanning signal G(n), and the control terminal of the transistor T1 is coupled to the node N1B. The clock signal CK1 and the clock signal CK2 may not be at a high voltage at the same time.

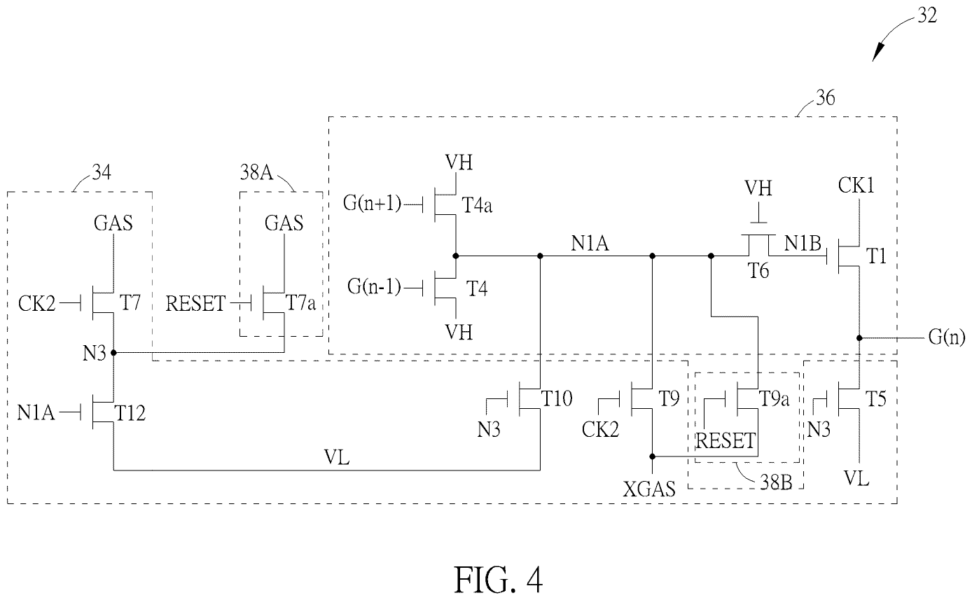

Please refer to FIG. 4, which is another circuit diagram of the scanning unit 32. In this embodiment, the scanning unit 32 further comprises a reset circuit 38A and a reset circuit 38B. The reset circuit 38A comprises a reset transistor T7a, and the reset circuit 38B comprises a reset transistor T9a. The first terminal of the reset transistor T7a receives the first power supply voltage GAS, the second terminal of the reset transistor T7a is coupled to the node N3, and the control terminal of the reset transistor T7a receives the reset signal RESET. The first terminal of the reset transistor T9a is coupled to the node N1A, the second terminal of the reset transistor T9a receives the second power supply voltage XGAS, and the control terminal of the reset transistor T9a receives the reset signal RESET.

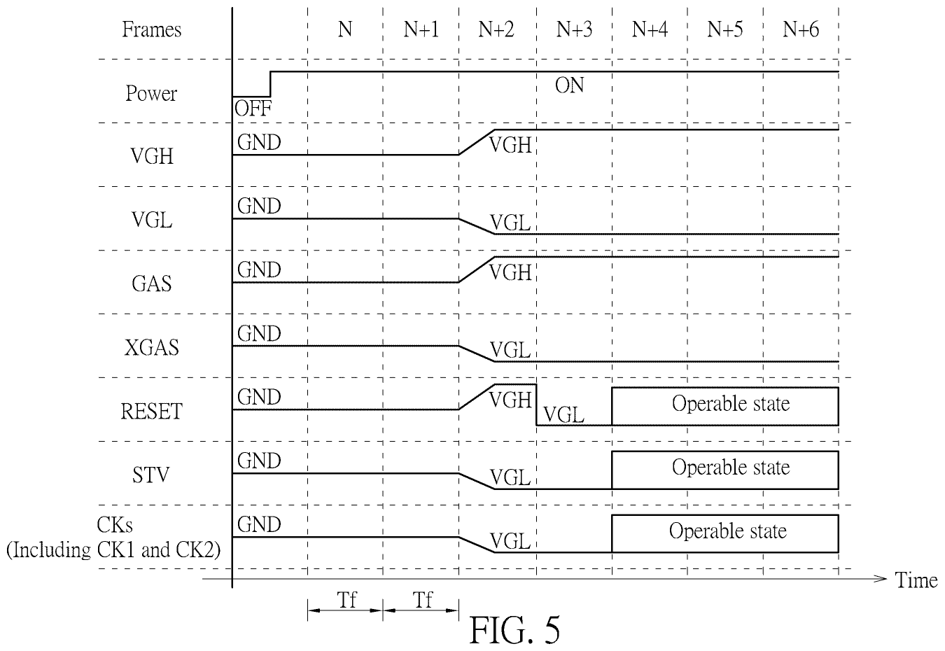

Please refer to FIG. 5, which is a timing diagram of the electronic device 10 shown in FIG. 1 when having the scanning unit 32 in FIG. 4. IIn the (N+2)th frame period, the gate high voltage VGH, the first power supply voltage GAS, and the reset signal RESET are pulled up from the ground voltage GND to a high voltage, and the gate low voltage VGL, the second power supply voltage XGAS, the first frame start pulse signal STV, and the initial clock signal CKs are pulled down from the ground voltage GND to a low voltage. Therefore, in the (N+2)th frame period, the reset transistor T7a and the reset transistor T9a will be turned on, so that the node N3 is at a high voltage, and the node N1A is at a low voltage, and the scanning signal G(n) is at a low voltage. In this way, in the (N+2)th frame period, the display components 52 of the display panel 50 will not display, and the display components 52 of the electronic device 10 may be prevented from malfunctioning when the electronic device 10 is just turned on. In this embodiment, since the reset transistors T7a and T9a will be turned on when the voltage of the reset signal RESET is at a high voltage, the high voltage (e.g., the gate high voltage VGH) may be defined as the reset voltage of the reset signal RESET. Furthermore, in the (N+3)th frame period, the gate high voltage VGH and the first power supply voltage GAS are maintained at a high voltage, the gate low voltage VGL, the second power supply voltage XGAS, the first frame start pulse signal STV, and the initial clock signal CKs are maintained at a low voltage, and the reset signal RESET is pulled down from the gate high voltage VGH to the gate low voltage VGL. Therefore, in the (N+3)th frame period, the reset transistor T7a and the reset transistor T9a will be turned off. After the (N+4)th frame period, the control unit 20 will cause the initial clock signal CKs, the reset signal RESET, and the first frame start pulse signal STV to all enter the operable state, so that the display panel 50 of the electronic device 10 displays normally. When the reset signal RESET is in the operable state, the waveform of the reset signal RESET in each frame period will be the same (e.g., when the reset signal RESET is in the operable state, the reset signal RESET comprises one pulse in each frame period).

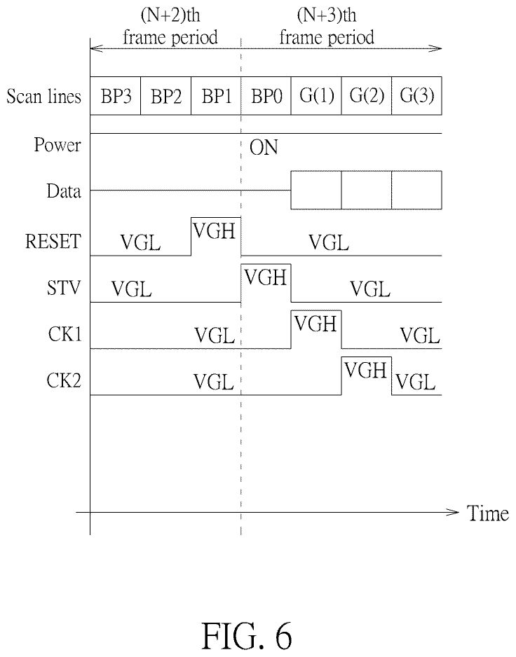

Please refer to FIG. 6, which is another timing diagram of the electronic device 10 shown in FIG. 1 when having the scanning unit 32 in FIG. 4. The timing diagram of FIG. 6 further illustrates the changes of the reset signal RESET in the (N+2)th frame period and the (N+3)th frame period. In this embodiment, the period during which the voltage of the reset signal RESET is at the reset voltage (e.g., the gate high voltage VGH) lasts for the scanning time of one scanning line. Wherein, BP0 to BP3 represent the scanning times of a plurality of back porch scanning lines of the display panel 50. In addition, the “Data” shown in FIG. 6 represents the data signal output by the source driver 40 to the display panel 50.

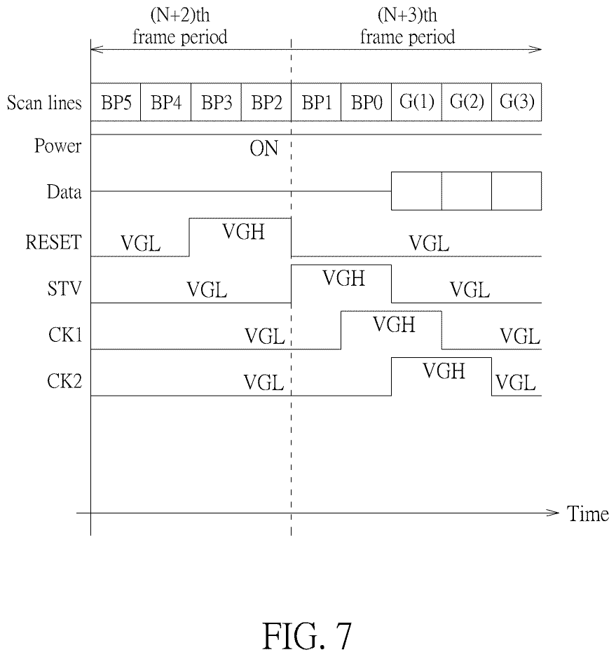

Please refer to FIG. 7, which is another timing diagram of the electronic device 10 shown in FIG. 1 when having the scanning unit 32 in FIG. 4. Similar to FIG. 6, the timing diagram of FIG. 7 also further illustrates the changes of the voltage of the reset signal RESET in the (N+2)th frame period and the (N+3)th frame period. In this embodiment, the period during which the voltage of the reset signal RESET is at the reset voltage (e.g., the gate high voltage VGH) lasts for the scanning times of two scanning lines. Wherein, BP0 to BP5 represent the scanning times of a plurality of back porch scanning lines of the display panel 50.

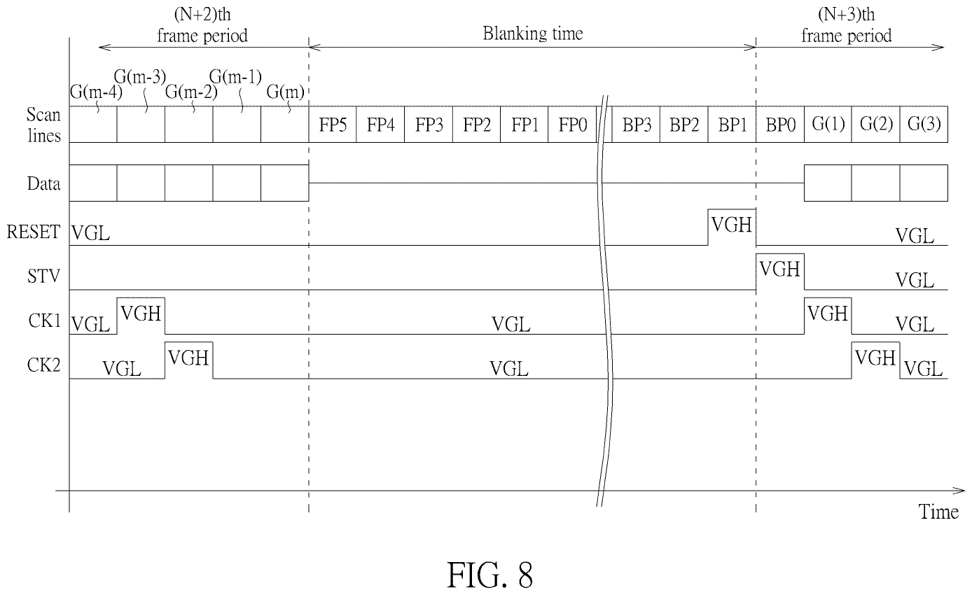

Please refer to FIG. 8, which is another timing diagram of the electronic device 10 shown in FIG. 1 when having the scanning unit 32 in FIG. 4. In this embodiment, there is another blanking time in the timing between the (N+2)th frame period and the (N+3)th frame period, and the blanking time may include the scanning times FP0 to FP5 of a plurality of front porch scanning lines and the scanning times BP1 to BP3 of a plurality of back porch scanning lines. The reset signal RESET is pulled up from the gate low voltage VGL to the gate high voltage VGH during the blanking time before the (N+3)th frame period. Wherein, the period during which the voltage of the reset signal RESET is at the reset voltage (e.g., the gate high voltage VGH) lasts for the scanning time of one scanning line.

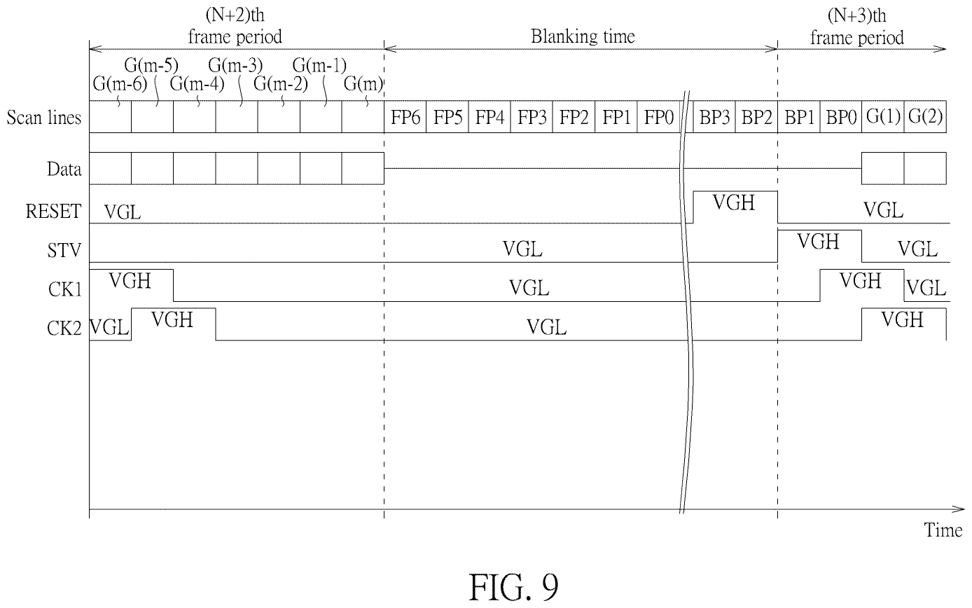

Please refer to FIG. 9, which is another timing diagram of the electronic device 10 shown in FIG. 1 when having the scanning unit 32 in FIG. 4. Similar to FIG. 8, the timing diagram of FIG. 9 also illustrates the changes of the voltage of the reset signal RESET during the blanking time. In this embodiment, the blanking time may include the scanning times FP0 to FP6 of a plurality of front porch scanning lines and the scanning times BP2 to BP3 of a plurality of back porch scanning lines. The reset signal RESET is pulled up from the gate low voltage VGL to the gate high voltage VGH during the blanking time before the (N+3)th frame period. Wherein, the period during which the voltage of the reset signal RESET is at the reset voltage (e.g., the gate high voltage VGH) lasts for the scanning times of two scanning lines.

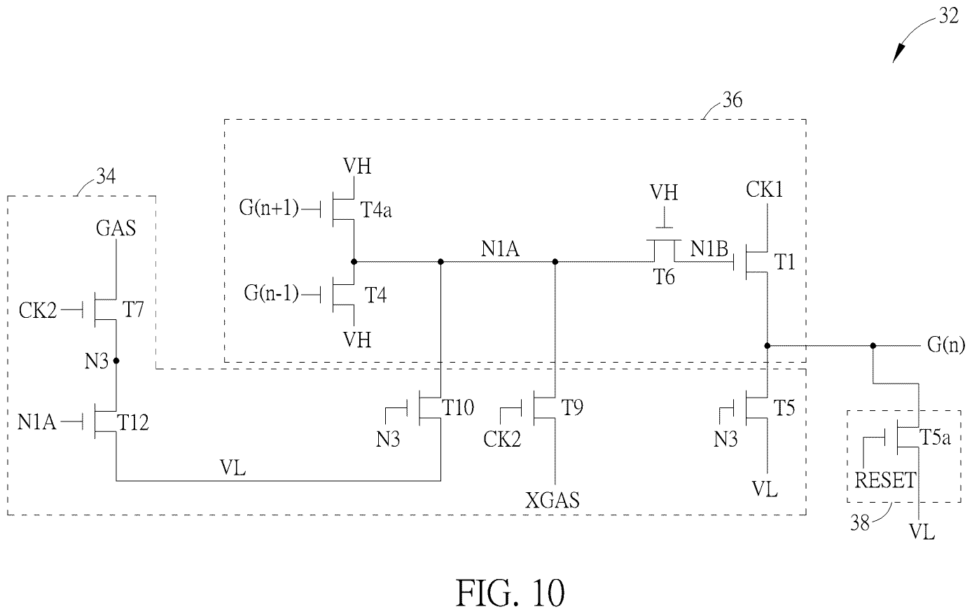

Please refer to FIG. 10, which is another circuit diagram of the scanning unit 32 of the electronic device 10 shown in FIG. 1. In this embodiment, the scanning unit 32 further comprises a reset circuit 38. The reset circuit 38 comprises a reset transistor T5a. The first terminal of the reset transistor T5a outputs the scanning signal G(n), the second terminal of the reset transistor T5a receives the low voltage VL, and the control terminal of the reset transistor T5a receives the reset signal RESET. When the voltage of the reset signal RESET is at the reset voltage (e.g., the gate high voltage VGH), the reset transistor T5a is turned on, so that the scanning signal G(n) is at a low voltage. Therefore, in the above-mentioned (N+2)th frame period, the display components 52 of the display panel 50 will not display, so the display components 52 of the electronic device 10 may be prevented from malfunctioning when the electronic device 10 is just turned on.

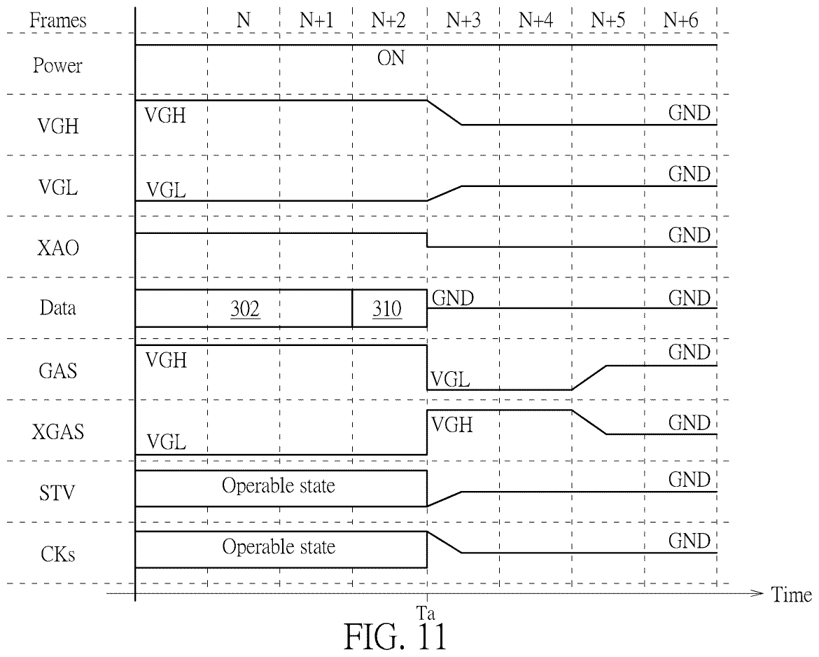

In an embodiment of the disclosure, the electronic device 10 has a variable refresh rate (VRR) function. Please refer to FIG. 11, which is another timing diagram of the electronic device 10 shown in FIG. 1. In this embodiment, the electronic device 10 is in a low rate (LR) power-saving mode before time Ta. After time Ta, the electronic device 10 is in a sleep mode, and the gate high voltage VGH is pulled down to the ground voltage GND, and the gate low voltage VGL is pulled up to the ground voltage GND. When the electronic device 10 operates in the power-saving mode, the control unit 20 causes the first frame start pulse signal STV to be in an operable state, and in the last frame period before the end of the power-saving mode (i.e., the (N+2)th frame period in FIG. 11), provides a black insertion signal 310 to the display components 52 of the display panel 50 to cause the display panel 50 to display a black screen. When the (N+2)th frame period ends, the control unit 20 will cause the electronic device 10 to enter the sleep mode. In this embodiment, the data signal transmitted by the source driver 40 before the (N+2)th frame period is a normal display signal 302, so that the display panel 50 can display a normal picture (e.g., a color picture). The voltage range of the above-mentioned black insertion signal 310 may be from −0.5 volts to +0.5 volts. Since the control unit 20 provides the black insertion signal 310 to the display components 52 of the display panel 50 in the last frame period before the end of the power-saving mode, the electronic device 10 may be prevented from generating an extremely large discharge current at the moment of entering the sleep mode, so the stability of the power supply voltage of the electronic device 10 may be maintained, and the operation of the control unit 20 may be prevented from being affected by the sudden drop of the power supply voltage. XAO in FIG. 11 represents the discharge signal of the electronic device 10. When the discharge signal XAO is pulled down from a high voltage to a low voltage (e.g., the ground voltage GND), the control unit 20 controls the display components 52 of the display panel 50 to discharge, so as to release excessive charge in the display components 52. In some other embodiments, the control unit 20 provides the black insertion signal 310 to the display components 52 of the display panel 50 in the last one to three frame periods before the end of the power-saving mode (i.e., the black insertion signal is provided between the (N)th and (N+2)th frame periods in FIG. 11), but the disclosure is not limited thereto.

In summary, the electronic device of the present disclosure ensures display stability during startup through precise STV timing and reset transistor configurations. During mode transitions, providing a black insertion signal buffers discharge currents, preventing power supply instability and ensuring normal system switching between different working modes.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. An electronic device, comprising:
a control unit configured to provide an initial clock signal and a first frame start pulse signal; and
a display component electrically connected to the control unit and controlled by the control unit within a plurality of frame periods;
wherein the plurality of frame periods comprises a first frame period and a second frame period immediately following the first frame period, the control unit causes the initial clock signal to enter a first operable state in the first frame period, and the control unit causes the first frame start pulse signal to enter a second operable state in the second frame period.

2. The electronic device of claim 1, when the initial clock signal is in the first operable state, a waveform of the initial clock signal in each frame period will be the same and will include at least one clock pulse.

3. The electronic device of claim 1, when the first frame start pulse signal is in the second operable state, the first frame start pulse signal comprises one impulse in each frame period.

4. The electronic device of claim 1, wherein each frame period is of equal length.

5. An electronic device, comprising:
a control unit configured to provide an initial clock signal and a reset signal;
a display component electrically connected to the control unit and controlled by the control unit within a plurality of frame periods;
a pull-up unit electrically connected to the control unit; and
a reset transistor electrically connected to the pull-up unit and having a control terminal for receiving the reset signal;
wherein the control unit causes the initial clock signal to enter an operable state in a first frame period, and the control unit sets a voltage of the reset signal to be a reset voltage before the first frame period.

6. The electronic device of claim 5, wherein the control unit sets the voltage of the reset signal to be the reset voltage between the device being powered on and the first frame period.

7. The electronic device of claim 5, wherein a period during which the voltage of the reset signal is the reset voltage lasts for a scanning time of 1 to 2 scan lines.

8. The electronic device of claim 5, wherein the pull-up unit is configured to pull up a voltage of a scan line coupled to the display component.

9. The electronic device of claim 8, further comprising a pull-down unit electronically connected to the pull-up unit for pulling down the voltage of the scan line.

10. The electronic device of claim 5, wherein the reset voltage is a gate high voltage.

11. The electronic device of claim 10, wherein the gate high voltage is a positive voltage.

12. The electronic device of claim 5, wherein when the voltage of the reset signal is the reset voltage, the reset transistor is turned on, so that a voltage of a scan line coupled to the display component is at a low voltage.

13. The electronic device of claim 5, wherein the pull-up unit comprises a least a transistor, and a first end of the least a transistor receives the initial clock signal.

14. An electronic device, comprising:
a control unit configured to provide an initial clock signal and a first frame start pulse signal; and
a display component electrically connected to the control unit and controlled by the control unit within a plurality of frame periods;
wherein, when the electronic device operates in a first mode, the control unit causes the first frame start pulse signal to be in an operable state, and provides a black insertion signal to the display component during at least one last frame period before an end of the first mode; and
wherein, when the at least one last frame period ends, the control unit causes the electronic device to enter a sleep mode.

15. The electronic device of claim 14, wherein the at least one last frame period comprises a last one to three frame periods.

16. The electronic device of claim 14, wherein the first mode is a power-saving mode.

17. The electronic device of claim 14, wherein a voltage range of the black insertion signal is from −0.5 volts to +0.5 volts.

18. The electronic device of claim 14, wherein the electronic device has a variable refresh rate (VRR) function.

19. The electronic device of claim 14, wherein the control unit provides a normal display signal to the display component before the at least one last frame period.

20. The electronic device of claim 14, wherein when the electrical device is in the sleep mode, a discharge signal is pulled down from a high voltage to a low voltage.
